(19) United States
(12) Patent Application Publication
(10) Pub. No.: US 2007/0181259 A1
(43) Pub. Date: Aug. 9, 2007

(54) Method And Apparatus For Making Three-Dimensional Objects

(75) Inventor: Yossi Bar-Erez, Kfar Sirkin (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: SOLIDIMENSION LTD, Beerot Itzhak (IL)

(21) Appl. No.: 11/623,342

(22) Filed: Jan. 16, 2007

Related U.S. Application Data
(63) Continuation of application No. 09/581,990, filed on Jun. 21, 2000, now abandoned.

(30) Foreign Application Priority Data
Jan. 5, 1999 (IL) PCT/IL98/00623
Jan. 5, 1998 (IL) 122857

(51) Int. Cl. B32B 37/12; B32B 37/26; B32B 38/04; B32B 37/18

(52) U.S. Cl. 156/524; 156/516; 156/526; 156/537; 156/558; 156/559; 156/578

(57) ABSTRACT

A method of and apparatus for making a three-dimensional object (2) made of a plurality of performed sheets (3), one atop the other, The method includes coating one side of one sheet (3) with adhesive using applicator (20), coating the adhesive with a release agent using applicator (22), bonding the opposite side of twice coating sheet (3) to a sheet (3) thereunder using adhesive on the surface of sheet (3) thereunder, and cutting twice coated sheet (3) using cutter (30). These steps are repeated until the desired number of sheets (3) is provided in a stack. The release agent is coated only in those areas of sheets (3) which will not be part of object (2), and cutting of each sheet (3) is along a contour corresponding to the contour of the same respective layer in object (2). After the steps have stopped, portion of the stack where the release layer is present and which is not part of object (2) is removed from the stack to give object (2).

This application is a Continuation of U.S. patent application Ser. No. 09/581,990 filed 21 Jun. 2000.

### FIELD AND BACKGROUND OF THE INVENTION

The present invention relates to a method, and also to apparatus, for making three-dimensional objects, such as models, dies, molds, and the like.

The invention is particularly applicable to the method of making three-dimensional objects by bonding together a large number of relatively thin layers each having the contour of a thin slice of the object, Such methods are of particular interest today since they may take advantage of the highly-developed computer-aided design (CAD) techniques, as well as computer-aided manufacture (CAM) techniques., For example, U.S. Pat. No. 5,071,503 describes such a technique in which each layer is a preformed sheet and is bonded to the partially-built object by applying an adhesive at locations defining, and within the confines of, the contour of the respective sheet, such that the portions of the sheet outside the contour are easily separated

### OBJECT AND SUMMARY OF THE INVENTION

An object of the present invention is to provide a novel method, and also apparatus, having advantages over the known techniques such as described in the above-cited patent.

According to one aspect of the present invention, there is provided a method of making a three-dimensional object constituted of a large number of thin preformed sheets each bonded on its opposite sides to the next adjacent sheets on its opposite sides, with each sheet cut along a contour corresponding to the contour of the respective layer constituted by the sheet in the object, characterized in: coating one side of each sheet, before being cut along its respective contour and bonded to the next adjacent sheet on that side, with a releasing agent which does not cover the surface of the sheet within the contour of the layer constituted by the respective sheet within the object, such that, after the respective sheet has been cut and bonded to the next adjacent sheet on that side, only the surface of the sheet within its respective contour is bonded to the next adjacent sheet, permitting the remaining non-bonded portion of the respective sheet not within the contour to be separated from the next adjacent sheet and the three-dimensional object,

Thus, whereas the method of the above-cited patent applies an adhesive to selected surfaces within the contour of the respective layer in the object, the present invention applies a releasing agent to selected surfaces outside of the contour.

The sheets may be precoated with an adhesive on one surface, or individually coated on the one surface during the application of the releasing agent to the opposite surface. The method of the present invention is thus easier to implement since it does not require precise control of the adhesive, but rather only precise control of the releasing agent, which is much easier to implement because of the nature of the two substances, Also, since the portions of the preformed sheets not to become a part of the produced object (i.e., the waste) are non-adhering to each other, they are easily removed from the produced object.

According to further features in the described preferred embodiments, the sheets are individually fed to, and stacked on, a horizontal table which is successively lowered as the sheets are successively stacked thereon. Each sheet is coated on its upper surface outside of its respective contour with the releasing agent, and on its under surface with the adhesive, as the sheet is fed to the horizontal table to be stacked on top of the other sheets thereon

In one described preferred embodiment, each individual sheet is coated on its upper surface with the releasing agent by a releasing-agent applicator controlled to apply the releasing agent outside of the contour of the respective sheet while the sheet is moving. In a second described embodiment, each individual sheet is coated on its upper surface with the releasing agent by a moving releasing-agent applicator controlled to apply the releasing agent outside of the contour of the respective sheet while the sheet is stationary,

The invention also provides apparatus for making three-dimensional objects in accordance with the above-described technique.

Further features and advantages of the invention will be apparent from the description below.

### BRIEF DESCRIPTION OF THE DRAWINGS

The invention is herein described, by way of example only, with reference to the accompanying drawings, wherein:

FIG. 1 is a three-dimensional view illustrating one form of apparatus constructed in accordance with the present invention;

FIG. 2 is a three-dimensional view from the opposite side of the apparatus of FIG. 1;

FIGS, 3a-3c schematically illustrate how a three-dimensional object is produced by the method and apparatus illustrated in FIGS. 1 and 2; and

FIGS. 4 and 5 are three-dimensional views corresponding to FIGS. 1 and 2, respectively, illustrating a second form of apparatus constructed in accordance with the present invention.

### DESCRIPTION OF PREFERRED EMBODIMENTS

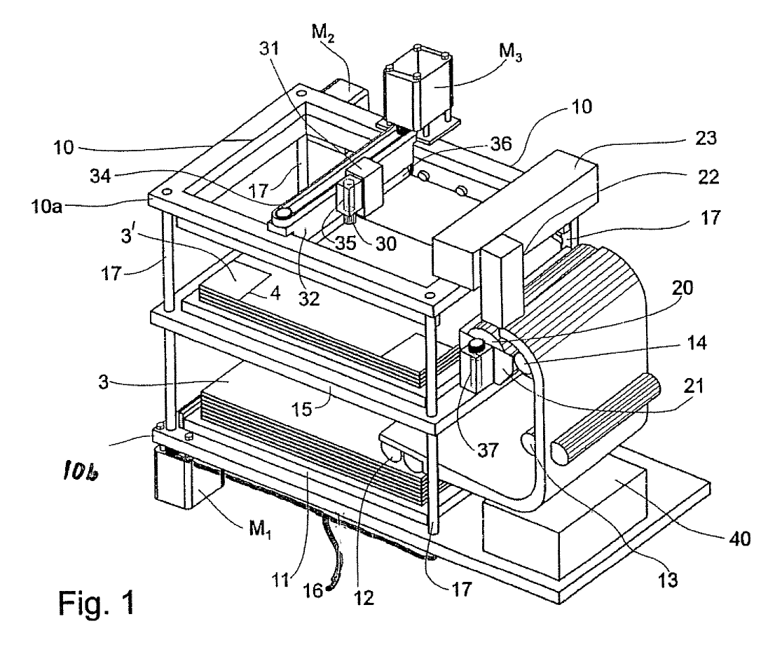

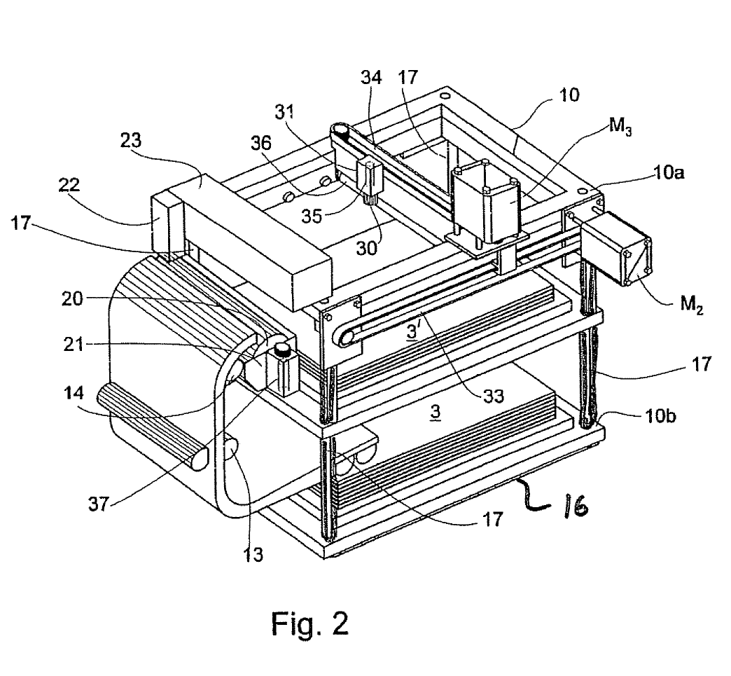

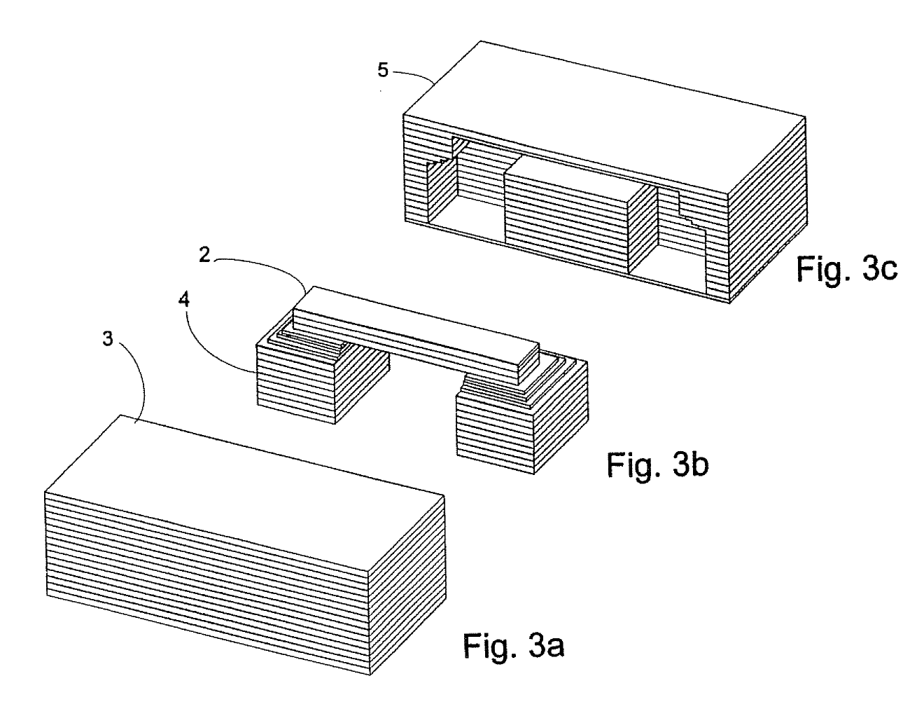

The apparatus illustrated in FIGS. 1 and 2 is used for making a three-dimensional object 2, such as illustrated in FIG. 3, from a large number of thin preformed sheets 3 bonded together with each sheet cut along a contour 4 corresponding to the contour of the respective layer in the object. The sheets 3, after being cut along their contours 4 and bonded together, are shown at 3′ in FIGS. 1 and 2, The waste remaining after the three-dimensional object 2 has been removed, is shown at 5 in FIG. 3.

The apparatus of FIGS. 1 and 2 includes a machine frame 10 including an upper section 10a and a lower section 10b . The preformed sheets 3 used in making the three-dimensional object 2 are supported in the form of a vertical stack on a horizontal base 11 fixed to the lower section 10b of the machine frame. Each sheet 3 is fed from the top of the stack on base 11 by feed rolls 12, 13, 14, to the upper section 10a of the machine frame 10 to overlie a table 15 on which the three-dimensional object 2 is built layer-by-layer Table 15 is driven in the vertical direction by an electrical motor M1 and a closed-loop belt 16 coupled to rotate four screws 17 journalled between the upper and lower machine frame sections 10a, 10b, and threadedly received through the four corners of the table 15.

The upper section 10a of the machine frame 10 includes an adhesive applicator 20 which applies a coating of adhesive from a reservoir 21 to the under side of each sheet 3 as it is fed to the upper end 10a of the machine frame 10.

A second applicator 22 is also located at the upper end of the machine frame 10 to apply a releasing agent to the upper side of each sheet 3 as it is fed to the upper end 10a of the machine frame overlying table 15. Applicator 22 coats the upper surface of each sheet. 3 with a releasing agent to cover the complete upper surface of the sheet except for the portion there of within the contour 4 of the respective layer of the finished three-dimensional object 2 constituted by the respective sheet.

In the example illustrated in FIGS. 1 and 2, the releasing agent applicator 22 is a print head which is movable along one orthogonal axis (the transverse Y-axis) as the sheet 3 is fed along the other orthogonal axis (the longitudinal X-axis) so that the applicator scans the complete upper surface of the sheet, The releasing-agent applicator 22 may be any suitable type of printing head, such as a liquid jet-ink printer, an impact-type printer, a laser printer, or the like. It applies to selected portions of the upper surface of each preformed sheet 3 a material, liquid or solid, which serves as a releasing agent with respect to the adhesive applied to the complete under surface of the sheet by applicator 20, such that an overlying sheet will not bond to an underlying sheet along the contacted surfaces which include the releasing agent, but will permit bonding where no releasing agent is present.

Applicator 22 is controlled by elements within its housing 23 to apply the releasing agent in the form of a negative pattern with respect to the contour 4 of the respective layer in the finished three-dimensional object 2.

That is, the releasing agent is applied to cover all the surfaces of the preformed sheet 3 except the surfaces within the contour 4 of the respective layer in the finished object Thus, each overlying sheet 3 will become bonded to the next adjacent underlying sheet 3 only within the contour 4 of the layer defined by the overlying sheet, and will not be bonded to the underlying sheet outside of that contour.

The apparatus illustrated in FIGS. 1 and 2 further includes a cutting tool 30 which is controlled to cut along the contour 4 of the respective layer 3 in the finished object 2. Cutting tool 30 is mounted on a head 31 carried by a carriage 32. The carriage 32 is driven in the longitudinal direction (X-axis) with respect to the machine frame 10 by a motor M2 and a closed-loop belt 33 (FIG. 2); whereas the head 31 is driven transversely of carriage 32 by another motor M3 and a closed-loop belt 34. Cutter head 30 is also movable in the vertical direction by a solenoid 35 carried by the head 31 to an extended cutting position for cutting the underlying sheet 3 or to a retracted non-cutting position, A pressure roller 36 firmly presses the sheet, as it is being cut, against the previously processed sheets supported by table 15.

The adhesive applicator 20 is also provided with a solenoid 37 to move the adhesive applicator either to an operative position or to a non-operative position. For example, the adhesive applicator would be moved to a non-operative position when the first sheet 3 is fed so as to prevent that sheet from adhering to the table 15,

The illustrated apparatus further includes a controller, generally designated 40, for controlling the motors M1, M2, M3, the adhesive applicator 20, the releasilng-agent applicator 22, the cutter tool 30, and the two solenoids 35 and 37, to produce the following operation:

A plurality of preformed rectangular sheets 3 to be used in producing the three-dimensional object 2, e.g,, as illustrated in FIG. 3a, are supported in a vertical stack on the machine base plate 11 at the lower end 10b of the machine frame, and each is individually fed to the upper end 10a of the machine frame to overlie the table 15 on which the finished three-diimensional object 2 is built layer-by-layer. In the initial condition of the apparatus, table 15 is at its uppernost position, and as each layer of the object is formed oil it, the table is successively moved vertically downwardly by motor M1 belt 16 and screws 17, to accommodate the newly-added layer as it is applied to the objects

As each sheet 3, except the first sheet to contact table 15, is fed by the feed rollers 12, 13, 14 to the upper end 10a of the machine frame 10, the underside of the sheet is completely coated with adhesive by adhesive applicator 20, and its upper side is selectively coated by applicator 22 with a releasing agent which does not bond to the adhesive The adhesive layer applied by applicator 20 covers the complete under surface of the respective sheet, whereas the releasing agent applied by applicator 22 covers only the upper surface of the sheet which does not come within the contour 4 of the respective layer of the sheet in the finished three-dimensional article. For example, if the respective layer to be formed by the sheet in the finished three-dimensional article is of a square contour, the rectangular sheet 3 to define that layer would be coated with the releasing agent only on its surface which is outwardly of the square defining the respective layer in the finished article; i.e., the surface within the square would not be covered by the releasing agent.

It will be appreciated that the contours of the finished article layers to be produced by the preformed sheets 3 would be stored in a CAD or CAM format within controller 40, or in a separate memory accessible by the controller, to be used by the controller for controlling the releasing-agent applicator 22, and the cutter tool 30, when the respective sheet 3 is being processed.

After the respective sheet 3 has been placed on top of the stack on table 15, completely coated on its under surface with adhesive, and selectively coated on its upper surface with the releasing agent corresponding to the contour for that sheet, as described above, the cutter tool 30 is controlled, also by controller 40, to cut the sheet along the contour line 4 for the respective sheet. For this purpose, the controller 40 controls the two motors M2 and M3 driving the cutter tool 30 along the two orthogonal axes, and also controls the solenoid 35 for moving the cutter tool 30 to and away from its operative cutting position.

The three-dimenisional model 2 is thus built up from the table 15, layer-by-layer, with each layer constituting a slice of the overall model. When all the layers have thus been applied, each layer adheres to the adjacent ones on both sides only along the portions thereof not coated with the releasing agent. Thus, after all the sheets for the entire three-dimensional object 2 have been cut and bonded together, the sheets adhere together only at their contacting surfaces within the contour 4 constituting the corresponding cross-section of the finished three-dimnensional object, permitting the remaining non-bonded portions of the sheets not within such contour to be separated from the three-dimensional object, This is shown in FIGS. 3a-3c, wherein it will be seen that the initial stack of sheets are shown at 3, the three-dimensional object produced therefrom is shown at 2, and the portions of the sheets not within the bonded contour surfaces, and to be separated from the object, are shown at 5.

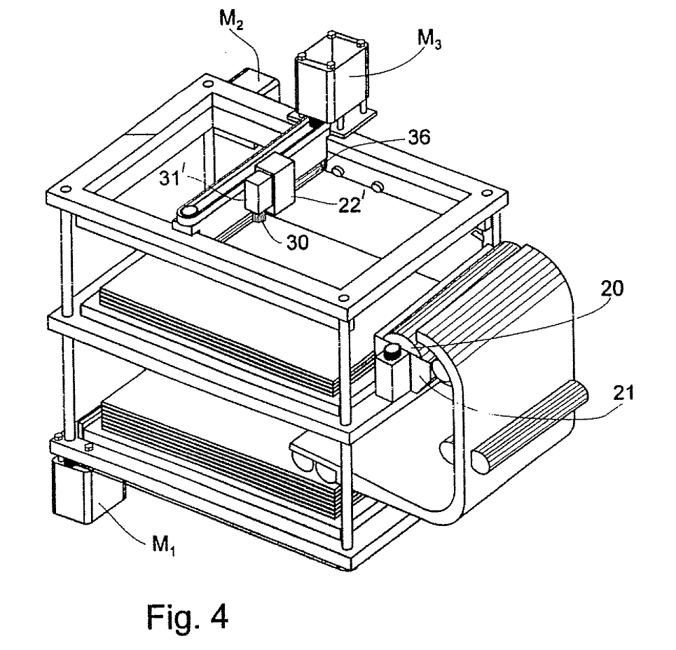

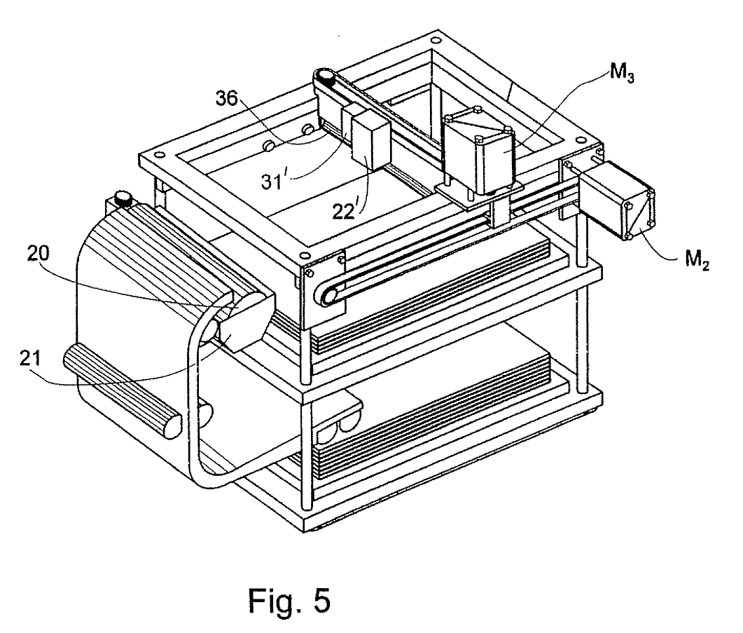

FIG. 4 illustrates an apparatus very similar to that of FIGS. 1 and 2. In order to facilitate understanding, those parts in the apparatus of FIG. 4 common to those of FIGS, 1 and 2 are identified by the same reference numerals.

The main difference in the apparatus illustrated in FIG. 4 is that the releasing-agent applicator, designated 22′ in FIG. 4, is carried on the same head 31′ as the cutting tool 30. Therefore, in the apparatus of FIGS. 4, the sheet 3 is stationary, not only at the time of cutting the contour by the cutting tool 30, but also at the time the releasing agent is applied by the applicator 22′, Thus, the releasing-agent applicator 22′ is also driven both longitudinally and transversely with respect to the sheet 3 in order to selectively apply the releasing agent to the upper surface of the respective sheet as described above with respect to FIGS. 1 and 2.

In substantially all other respects, the apparatus illustrated in FIG. 4 is constructed and operates as described above with respect to the apparatus of FIGS. 1 and 2.

The sheets 3 may be of any suitable plastic material, such as polyvinylclhloride, epoxy resin, nylon etc.

They should be of the appropriate thickness corresponding to the exactness required in the finished object to be produced by the apparatus. Preferably, the sheets 3 should be of the order of 0.1 mm in thickness, thereby requiring about 100 such sheets to be processed for each one-centimeter height of the three-dimensional object to be produced

The releasing agent may be of any suitable material which does not bond to the adhesive used, As one example, the releasing agent may be a wax composition.

While the illustrated apparatus shows the adhesive being applied to the under surface of each sheet at the time each sheet is processed, it will be appreciated that the preformed sheets may be pre-coated with the adhesive before being applied to the apparatus. It is also contemplated that the preformed sheets may be bonded together by applying a solvent to the under surface of the respective sheet to thereby soften it and to promote its bonding to the overlying sheet except where the upper surface of the respective sheet is selectively covered by the releasing agent. It is further contemplated that an adhesive need not be used, but rather that the sheets themselves be bonded by heat and/or pressure except at those surfaces selectively covered by the releasing agent, which heat and/or pressure would be applied to the entire stack of sheets The cutting tool 30 may be heated. The bonding may be performed before, during, or after the cutting tool has been applied to cut the contour. The releasing agent could be coloured according to the desired colour of the produced object and could be applied in any shown manner, e.g., electrostatically, by a laser by a thennal printer, etc. The adhesive applicator could also be mounted for movement along one axis (e.g. transversely) as the preformed sheet is moved along the other axis.

Also, the releasing agent can be applied directly on top of the glue, or below the glue on the same side of the sheet, in which case the releasing agent applicator 22 would be mounted on the same side as the adhesive applicator 20.

Further, the sheet could be completely pre-coated with the releasing agent and such agent removed from the portion of the sheet to be glued, in which case unit 22 in FIG. 1 would be a “removing” unit, to remove the unwanted portion of the releasing agent mechanically, chemically, by laser, etc. Further, the glue could be applied to the upper face of the sheet, and the releasing agent on the bottom face, rather than vice versa described above.

Alternatively, rather than utilizing an adhesive from adhesive applicator 20 that will bond to an adjacent sheet except in areas to which the releasing agent from applicator 22 is applied, applicator 20 can apply an adhesive having the characteristics such that it will bond to an adjacent sheet only in areas to which an activating agent is applied by applicator 22. In this configuration, the activating agent is applied only to the portion within the contour 4, such that adjacent sheets will bond only in the contour area to which the activating agent is applied.

Many other variations, modifications and applications of the invention will be apparent.

What is claimed is:

1. An apparatus for making a three-dimensional object formed from a large number of thin layers each cut from flexible sheet material along a contour corresponding to the contour of the respective layer constituted by the sheet in the object and bonded together to form the three-dimensional object, the apparatus comprising:
a) a table for receiving the layers of sheet material;
b) a feed mechanism for delivering successive layers of sheet material to said table;
c) a cutting tool for cutting each successive layer along the required contour;
d) an adhesive applicator for applying a coating of a bonding agent on one side of each layer for bonding adjacent layers of sheet material;
e) a releasing agent applicator for selectively applying a coating on one side of each layer of sheet material of a releasing agent effective to prevent bonding of adjacent sheets where said releasing agent has been applied, thereby facilitating separation of the final object from residue material of the flexible sheet material;
f) a roller for rolling across said layers of sheet material; and
g) a drive arrangement including:
i) a bridge extending across said table in a first direction and displaceable along said table in a second direction, and
ii) a head displaceable along said bridge,
wherein all of said cutting tool, said releasing agent applicator and said roller are displaced by said drive arrangement.

2. The apparatus of according to claim 1, further comprising a vertical drive for lowering said table as said layers are successively stacked thereon.

3. The apparatus according to claim 2, wherein said vertical drive includes a screw mechanism including a rotary motor and a plurality of screws coupled to said table for raising and lowering the table.

4. The apparatus of according to claim 1, wherein said adhesive applicator applies a coating of a bonding agent over substantially the entirety of one side of each layer of the sheet material.

5. The apparatus according to claim 4, wherein said adhesive applicator extends across the entirety of one dimension of the sheet material, said bonding agent being applied during relative motion in a single direction between said adhesive applicator and the sheet material.

6. The apparatus of according to claim 1, wherein said bonding agent is a solvent for the sheet material.
